(19) United States
(12) Patent Application Publication
(10) Pub. No.: US 2012/0133065 A1
(43) Pub. Date: May 31, 2012

(54) REAL-TIME, CLOSED-LOOP SHAPE CONTROL OF EXTRUDED CERAMIC HONEYCOMB STRUCTURES

(76) Inventors: Stephen John Caffrey, Rochester, NY (US); Joseph Henry Citriniti, Corning, NY (US); Robert John Locker, Corning, NY (US); Robert Bernard Lubberts, Woodhull, NY (US); Daniel Edward McCauley, Watkins Glen, NY (US); David Robert Potts, Blacksburg, VA (US); David Robertson Treacy, JR., Horseheads, NY (US); Casey Allen Volino, Tioga, PA (US)

(21) Appl. No.: 13/301,127

(22) Filed: Nov. 21, 2011

Related U.S. Application Data
(60) Provisional application No. 61/418,159, filed on Nov. 30, 2010.

(51) Int. Cl. B29C 45/76

(52) U.S. Cl. 264/40.1; 425/143

(57) ABSTRACT

Systems and methods for real-time, closed-loop shape control of extruded ceramic honeycomb structures are disclosed. Methods include extruding batch material through an extruder barrel and through an extruder die using at least one extrusion screw to form the extrudate, and measuring a shape of the extrudate immediately adjacent the die. The batch material water content is determined or measured, at least one of the extruder barrel and screw temperature are measured, and the extrusion screw rotation rate are measured. At least one of the batch material water content, barrel temperature, screw temperature and rotation rate is adjusted to maintain the extrudate shape to within a select tolerance.

### CROSS-REFERENCE TO RELATED APPLICATIONS

This application claims the benefit of priority under 35 U.S.C. §119 of U.S. Provisional Application No. 61/418,159 filed on Nov. 30, 2010, the content of which is relied upon and incorporated herein by reference in its entirety.

### FIELD

Various aspects of the disclosure generally relate to shape control of extruded ceramic honeycomb structures, and in particular relate to systems and methods for real-time, closed-loop shape control of extruded ceramic honeycomb structures.

### BACKGROUND

The process of forming a ceramic honeycomb structure involves forming an extrudate having a select or desired shape. Once extruded, it is difficult to change the extrudate shape in a controlled way, so that the extrudate shape must be within a certain tolerance of the desired shape upon extrusion. However, differences between a desired extrudate shape and the actual extrudate shape can occur. Present systems and methods for controlling the shape of an extrudate to within the select tolerance utilize inconvenient and time-consuming off-line measurements. This results in substantial product waste and reduced throughput, both of which add expense to the manufacturing process.

### SUMMARY

An aspect of the disclosure is a method for controlling a shape of a ceramic precursor extrudate. The method includes forming the extrudate by extruding a ceramic precursor batch material through a barrel and through an extruder die. The method also includes determining a batch material water content, measuring at least one of a barrel temperature and a screw temperature, and measuring a rotation rate of one or more extrusion screws within the barrel that control a rate of extrusion of the batch material through the die. The method further includes measuring the extrudate shape as the extrudate exits the die, and adjusting at least one of the batch material water content, barrel temperature, screw temperature and rotation rate to maintain the extrudate shape to within a select tolerance.

Another aspect of the disclosure is a ceramic precursor extrudate control system for controlling a shape of a ceramic precursor extrudate. The system includes an extruder having a barrel adapted to contain a batch material, and an extruder die operably disposed relative to the extruder barrel. The system also includes a temperature control device configured to control at least one of a barrel temperature and a screw temperature, and to provide a measurement of at least one of the barrel temperature and the screw temperature. The system also has a water unit configured to add a select amount of water to the batch material, with the select amount of water corresponding to a batch material moisture content. The system also has an extrusion screw system that includes at least one extrusion screw within the barrel. The at least one extrusion screw has a variable rotation rate, and the extrusion screw system can control the rate of extrusion of the batch material through the die and provide an extrusion screw rotation rate measurement. The system also includes a shape sensor arranged adjacent the die and configured to provide an extrudate shape measurement. The system further has a controller configured to receive the batch material moisture content, the barrel and screw temperature measurements, the extrusion screw rotation rate and the extrudate shape, and cause a change in at least one of the batch material moisture content, the barrel temperature, the screw temperature and the rotation rate to maintain the extrudate shape to within a select tolerance.

Another aspect of the invention is a method for controlling a shape of a ceramic extrudate formed by an extrusion system. The method includes extruding batch material through an extruder barrel and through an extruder die using at least one extrusion screw to form the extrudate. The method also includes measuring a shape of the extrudate immediately adjacent the die, determining a batch material water content, measuring a temperature of the extruder barrel and at least one screw, and measuring a rotation rate of the at least one extrusion screw. The method then involves adjusting at least one of the batch material water content, barrel temperature, screw temperature and the rotation rate to maintain the extrudate shape to within a select tolerance.

Additional features and advantages of the disclosure are set forth in the detailed description that follows and, in part, will be readily apparent to those skilled in the art from that description or recognized by practicing the disclosure as described herein, including the detailed description that follows, the claims, and the appended drawings.

It is to be understood that both the foregoing general description and the following detailed description present embodiments of the disclosure and are intended to provide an overview or framework for understanding the nature and character of the disclosure as it is claimed. The accompanying drawings are included to provide a further understanding of the disclosure and are incorporated into and constitute a part of this specification. The drawings illustrate some aspects and embodiments of the disclosure and, together with the description, serve to explain the principles and operations of the disclosure.

### BRIEF DESCRIPTION OF THE DRAWINGS

FIG. 1 is a schematic diagram of an example embodiment of an extrusion system used to form ceramic honeycomb structures and that is capable of providing real-time, closed-loop control of the extrudate shape;

FIG. 2 is an alternate schematic diagram of the extrusion system of FIG. 1;

FIG. 3 is an isometric view of an example extrudate, showing how the extrudate is cut into logs;

FIG. 4 is a close-up isometric view of an example greenware piece and the subsequent ceramic body formed from the original extrudate;

FIG. 5A through FIG. 5C are sweep curves for an example extrusion processes where the batch water is varied from 15.1% to 16.1% (FIG. 5A), rotation rate is varied from 16 to 20 RPM (FIG. 5B), and the barrel temperature is varied from −4° C. to +2° C. (FIG. 5C);

FIG. 6 is a hypothetical sweep curve representative of those shown in FIG. 5A through FIG. 5D, that shows how the pressure differential ΔP is calculated from measurements of the batch material skin temperature T_{34S} (triangle) and the batch material core temperature T_{34C} (diamond);

FIG. 7A through FIG. 7D are sweep curves for example extrusion processes where the rotation rate and barrel temperature were varied and the batch water was kept at a constant 15.5%, with respective extrudate shape contours (both desired shape S_{D} and measured shape S_{M}) shown for the corresponding sweep curve;

FIG. 8A through FIG. 8D are sweep curves for example extrusion processes similar to FIG. 7A through FIG. 7D, where the rotation rate and barrel temperature were varied and the batch water was kept at a constant 16.1%;

FIG. 9A through FIG. 9D are sweep curves for example extrusion processes similar to FIG. 7A through FIG. 7D, where the rotation rate and moisture content were varied and the barrel temperature was kept at a constant 1° C.;

FIG. 10 is a plot of the shape parameter SP vs. pressure differential ΔP (psi) as determined from a family of shape curves that include those of FIG. 7A-7D, 8A-8D and 9A-9D, illustrating the distribution of extrudate shape with pressure differential; and

FIG. 11 is a plot of the evolution of the extrudate shape with pressure differential for example data points A through D taken from the data of plot of FIG. 10, including a “good” shape parameter value SP=0 for data point B at about 150 psi.

FIG. 12 is a plot of extrudate shape variation (measured at the exit of the die) versus batch temperature variation (measured across the extruder barrel), showing correlation between shape variation and temperature variation.

### DETAILED DESCRIPTION

The ability to produce extrude-to-shape (ETS) ceramic honeycomb structures that meet a tight shape specification (e.g., a ±1.0 mm contour specification) depends on the ability to predict and adjust extrusion parameters for shrinkage, and to diagnose and correct shape errors in real time. Presently, shape control is performed using die conditioning, batch temperature control, and shrink-plate compensation. While batch temperature control to a fixed value (within a range) is an effective means for controlling shape and quality, it does not account for day-to-day changes in batch rheology, which can cause shape and process instabilities. Sudden changes in shape due to changes in the batch rheology can not only cause dimensional yield loss, but can require physical reconfiguration of the extrusion system (e.g., with new die and hardware set-up). Such system reconfiguration and the subsequent process stabilization can take anywhere from 1 to 3 hours.

While there is no known technology to directly measure the center-to-edge flow differential of an extrudate during extrusion, a present-day technique measures the pressure differential ΔP, which is the difference in center or core pressure P_{C} to the edge (skin) pressure P_{S}, i.e., ΔP═P_{C}−P_{S}. The pressure differential ΔP is measured off-line using, for example, a capillary rheometer. This measurement provides valuable information about the extrusion process and rheology. However, this pressure differential information is generated two to three hours after the extrusion has taken place, and this information alone is not sufficient for controlling the extrudate shape.

Reference is now made in detail to embodiments of the disclosure, examples of which are illustrated in the accompanying drawings. Whenever possible, the same reference numerals will be used throughout the drawings to refer to the same or like parts.

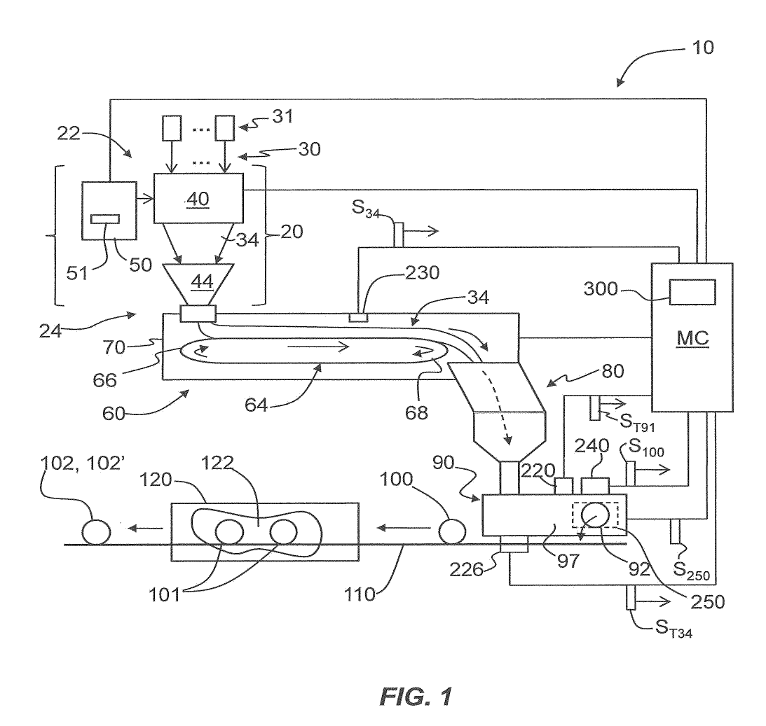

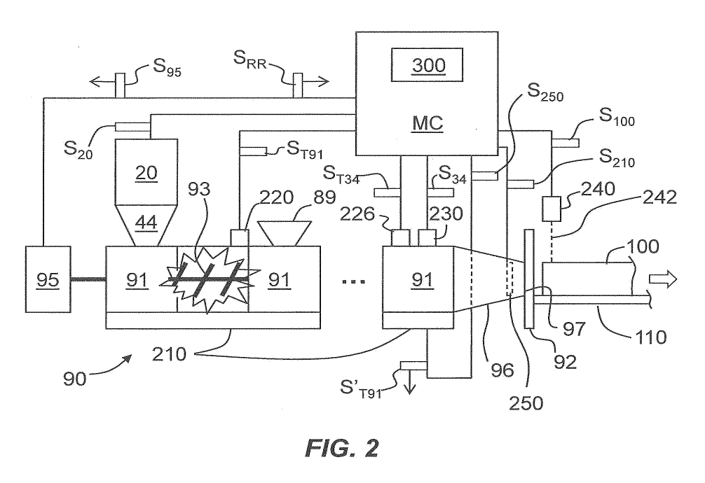

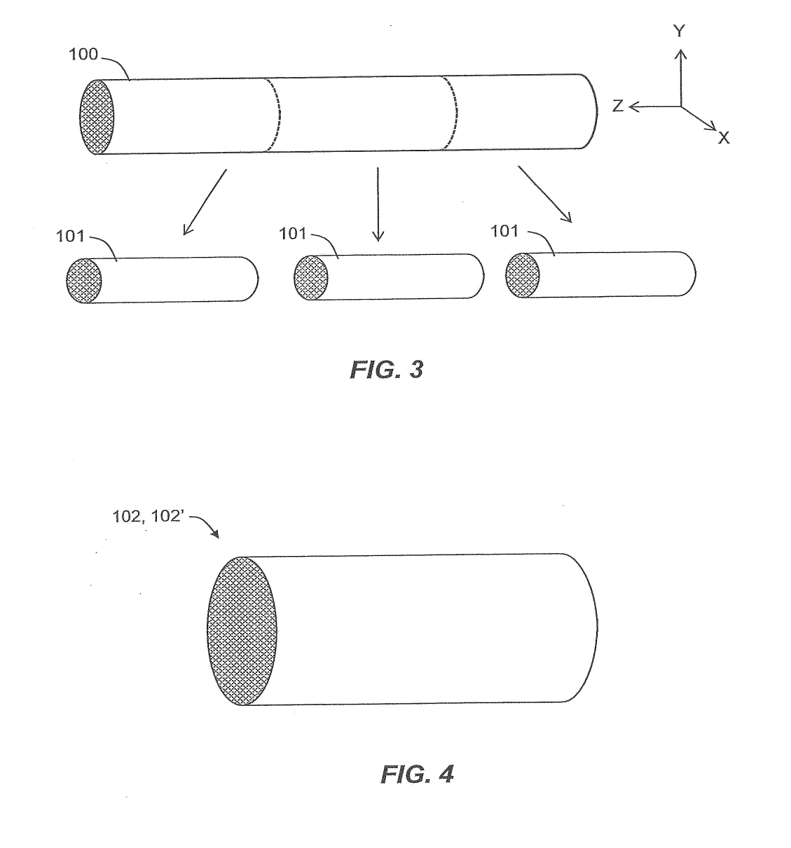

FIG. 1 is a schematic diagram of an example embodiment of an extrusion system 10 used to form ceramic honeycomb structures, such as extrudate 100 and subsequent ceramic honeycomb bodies 101, 102 and 102′ (see FIG. 3 and FIG. 4). System 10 is capable of providing real-time, closed-loop control of the extrudate shape. FIG. 2 is an alternate schematic diagram of extrusion system 10 that highlights certain system features. As used herein, real-time control means system 10 generates a control response within a time period that is sufficiently short to allow system 10 to maintain, control and/or modify the extrudate shape within predetermined limits as it is extruded.

Extrusion system 10 includes a mixing stage or “wet tower” 20 having an input end 22 and an output end 24. Wet tower 20 initially receives at input end 22 the various batch material constituents 30 in dry form from respective constituent sources 31, and mixes them along with water (and optionally oil) to form an initial ceramic-forming (ceramic precursor) batch material 34 having a batch material water content or “batch water.” The batch water is typically measured in weight percent (wt %) as compared to the dry weight of the batch material constituents (the symbol “%” is understood to mean weight-percent where applicable). Wet tower 20 includes, for example, a mixer 40 followed by a rotary cone 44. Wet tower 20 also includes a water unit 50 configured to provide water to mixer 40 in select amounts, e.g., by weighing the amount of water added to the mixer using a delivery scale 51. In an example, the batch water is determined by knowing the amount of water added to batch material constituents 30 using water unit 50. Further in an example, the batch water is adjusted by adjusting the amount of water added to the batch material (or the batch material constituents) in water unit 50 via delivery scale 51. In example embodiments, water unit 50 is controlled manually or automatically, as discussed below. Examples of batch material 34 are discussed below.

Extrusion system 10 further includes a conveyer unit 60 arranged adjacent output end 24 of wet tower 20. Conveyor unit 60 includes a conveyor belt 64 with an input end 66 and an output end 68. Conveyor belt 64 rotates clockwise as shown. Conveyor unit 60 includes a protective cover 70.

Conveyor belt input end 66 is arranged at the output end 24 of wet tower 20 to receive batch material 34 therefrom. In an example embodiment, rotary cone 44 serves to deliver batch material 34 to conveyor belt input end 66 in a relatively uniform layer. In an example embodiment, batch material 34 is carried by conveyor belt 64 in a layer having a thickness between about one inch and about two inches and a width between about ten inches and about fourteen inches. Wet tower 20 is configured to adjust the thickness of the layer of batch material 34 carried by conveyor belt 64.

Extrusion system 10 further includes a chute 80 and an extrusion unit 90. Chute 80 is arranged between conveyor unit 60 and extrusion unit 90. Chute 80 is configured to receive batch material 34 from the output end 68 of conveyor belt 64 and deliver it to extrusion unit 90, which includes one or more barrels 91 and an extruder section 96. The temperature of the one or more barrels 91 and extrusion screws 93 is regulated by a barrel and screw temperature control system 210, which in an example flows a barrel and screw coolant (not shown). In an example, barrel and screw temperature control system 210 is configured (e.g., with temperature sensors) to provide a measurement of the barrel and/or screw temperature T₉₁ of one or more barrels 91 and/or screws 93 via a temperature signal S′_{T91} that is sent to a master controller MC. In an example, one of barrels 91 includes a vacuum vent 89 that allows for the removal of gas from batch material 34.

Extrusion unit 90 is configured to receive batch material 34 and form billets therefrom, which are then pressed through an extrusion die 92 at an output end 97 of extruder section 96 to form extrudate 100. In an example, this is accomplished by one or more extrusion screws 93 driven by a motor 95, where the motor generates an electrical rotation rate signal S_{RR} that indicates the rotation rate RR of the one or more extrusion screws 93. Motor 95 and extrusion screws 93 constitute an extrusion screw system. In an example embodiment, extrusion unit 90 includes multiple extrusion dies 92 that operate at once to simultaneously form multiple extrudates 100. Extrusion unit 90 can also include multiple barrels 91, such as shown in FIG. 2.

In an example embodiment, extrusion system 10 includes at least one barrel temperature sensor 220, an optional batch moisture sensor 230, and a shape sensor unit 240 all electrically connected to a master controller MC. Motor 95 and barrel temperature control system 210 are also electrically connected to master controller MC. Barrel temperature sensor 220 is operatively arranged relative to at least one barrel 91 and generates an electrical temperature signal S_{T91} representative of the barrel temperature T₉₁. Electrical temperature signal S_{T91} is provided to master controller MC. In an example where temperature sensor 220 is part of barrel temperature control system 210, electrical temperature signal S′_{T91} is the same as electrical temperature signal S_{T91}.

Master controller MC also receives electrical rotation rate signal S_{RR} from motor 95 and can control the rotation rate RR via a motor control signal S₉₅.

The optional moisture sensor 230 is operatively arranged relative to batch material 34 and generates an electrical signal S_{M34} representative of the moisture content (“batch water”) M₃₄. In this case, electrical batch water signal S_{M34} is provided to master controller MC. An example moisture-content measurement system for an extrusion system is described in U.S. patent application Ser. No. 12/471,530, which is incorporated by reference herein. As discussed above, batch water M₃₄ can also be determined by knowing how much water is added to the batch material constituents 30 at water unit 50. Further, the batch water M₃₄ can be varied using delivery scale 51, which can be operated manually or automatically via master controller MC to add select amounts of water to form batch material 34 with a select batch water M₃₄.

In an example embodiment, extrusion system 10 includes an in-line temperature sensor 250 arranged in extrusion unit 90 in extruder section 96 adjacent to die 92. In-line temperature sensor 250 is configured to measure the batch material temperatures T₂₅₀ from the center or core (T_{34C}) to the edge or skin (T_{34S}) just prior to extrusion. In an example, in-line temperature sensor 250 is arranged from about 10 inches to about 12 inches behind die 92. In-line temperature sensor 250 generates electrical temperature signals S₂₅₀ corresponding to the measured temperatures T₂₅₀ of extrudate 100 across the extrudate (i.e., in the lateral cross-sectional direction).

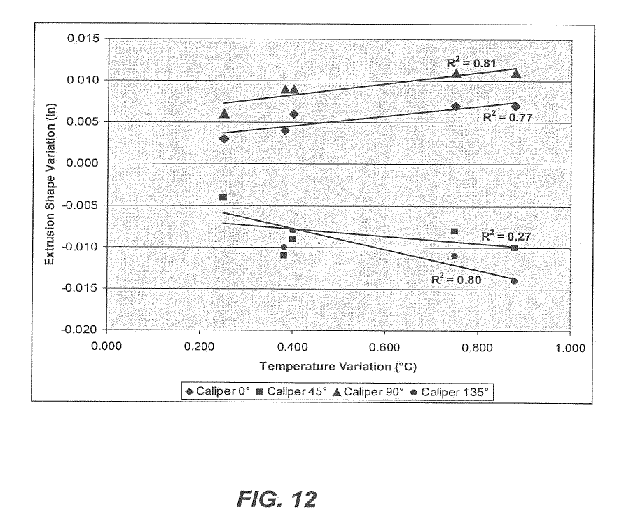

In an example, in-line temperature sensor 250 is electrically connected to master controller MC and provides electrical temperature signals S₂₅₀ thereto. In an example, the measured temperatures T₂₅₀ correspond to a temperature profile across extrudate 100 during extrusion through die 92. Such a temperature profile can assist in providing information about the pressure differential via temperature sweep curves (described below), which in turn provides information about flow rate of the extrudate through the die from the core to the skin, and thus provides information about the extrudate shape. Such a temperature profile also provides information about the shape of the extrudate at the exit of the extruder. Correlation between temperature and shape is demonstrated by the data provided in FIG. 12, which shows increasing shape variation with increasing temperature variation of the batch across the barrel. An example in-line temperature sensor 250 is described in U.S. patent application Ser. No. 12/788,389, which is incorporated by reference herein. Thus, in an embodiment, the temperature profile from in-line temperature sensor 250 is used to compare with a shape measurement from shape sensor unit 240 to ensure a correspondence between the measured shape and the parameters that should directly relate to the measured shape. This comparison may be carried out automatically in master controller MC.

In another embodiment, one or more measured temperatures T₂₅₀ of the temperature profile of extrudate 100 are measured manually on a sample extrudate. Manually measured temperatures T₂₅₀ can be obtained using, for example, a hand-held temperature probe. Other manual measurements of extrudate 100 can also be made, such as the extrudate hardness using, for example, a penetrometer. These manual measurements can be used as described above to ensure that the batch rheology is acting in a consistent manner, particularly with respect to the measured extrudate shape.

Shape sensor unit 240 is arranged adjacent die 92 and generates an electrical signal S₁₀₀ representative of the measured outer shape (profile) S_{M}(x,y,z) or S_{M}(r, θ, z) of extrudate 100 as it exits the die (see FIG. 3). The cross-sectional shape or contour is generally given by S(x,y) or S(r, θ) for a given z value, where z is measured along the length of extrudate 100 (see FIG. 3). The ideal or desired extrudate shape is denoted S_{D}. Electrical shape signal S₁₀₀, which is representative of the measured shape S_{M}, is provided to master controller MC. Master controller MC also includes the desired shape S_{D}, and is configured to compare the desired shape S_{D} to the measured shape S_{M}. In an example, shape sensor unit 240 uses a light beam 242 such as a laser beam to perform a non-contact shape measurement of extrudate 100. In one embodiment, shape sensor unit 240 is a laser and camera based measurement system, as is available from Bytewise Measurement Systems of Columbus, Ga., USA, as the Profile360™ Profile measurement System.

Master controller MC is also electrically connected to motor 95 to control the rotation rate RR (in rotations per minute or RPMs) of the one or more extrusion screws 93 via electrical RPM control signal S₉₅. Master controller MC is also optionally operably connected to wet tower 20 to control its operation relative to the overall operation of extrusion system 10. In particular, master controller MC can be configured to control the operation of water unit 50 in wet tower 20 to control the amount of water added to the batch material to control the batch material moisture content (batch water) M₃₄. Master controller controls wet tower 20 with a wet tower control signal S₂₀.

In one embodiment, the barrel temperature T₉₁ is measured at a barrel 91 whose temperature is controlled using barrel temperature control system 210, and the barrel temperature is changed in response to the measured batch material temperature T₃₄. The batch material temperature T₃₄ can be determined and compared to a temperature set-point T_{SET} for batch material 34. This information can be used to regulate the operation of barrel temperature control system 210 to control the barrel temperature T₉₁ to correspond to the batch material set-point temperature T_{SET}.

In an example, the batch material temperature T₃₄ can be measured in extruder system 10 using, for example, a temperature sensor 226 and corresponding electrical signal S_{T34} provided to master controller MC. Note, however, that batch material temperature measurements need not be used in the systems and methods described herein. Rather, the barrel temperature T₉₁ can be used.

With continuing reference to FIG. 1 and FIG. 2, extrudate 100 exits extrusion die 92 and is deposited onto a conveyor 110 arranged adjacent the extrusion die. Extrudate 100 constitutes an example of a ceramic honeycomb structure. In an example embodiment, extrudate 100 is cut into sections called “greenwares” or “logs” 101, as shown in FIG. 3. Logs 101 may be, for example about 3 feet in length. Greenwares 101 are then conveyed by conveyor 110 to a drying station (e.g., an oven or “applicator”) 120. Drying station 120 has an interior 122 where logs 101 reside while drying. Drying station 120 may use, for example, radio-frequency (RF) radiation or microwave frequency (MF) radiation, to effectuate drying.

The drying process is carried out until logs 101 are substantially dry, meaning that most or all of the liquid initially present in extrudate 100 has been removed so that the moisture content has been reduced to a level acceptable for cutting and firing the piece at high temperature. In example embodiments, logs 101 contain less than 2 wt % water, or in some cases less than 1 wt % water, upon exiting drying station 120. Having the proper moisture content at this stage is critical because logs that are too moist become damaged upon cutting (e.g., are subject to “smearing”), and can also damage the cutting saw.

If logs 101 are sufficiently dry, they are cut into smaller greenware pieces 102 (see FIG. 4) and the cut pieces fired (e.g., in a hot-air oven). This transforms greenware pieces 102 into respective ceramic bodies 102′ having a honeycomb structure with thin interconnecting porous walls that form parallel cell channels longitudinally extending between end faces, as shown in FIG. 4. In an example embodiment, ceramic body 102′ is used to form a ceramic filter. Note that extrudate 100, logs 101, greenware pieces 102 and ceramic body 102′ all constitute different forms of a ceramic honeycomb structure.

Exemplary ceramic bodies 102′ comprised of AT-based ceramic materials are discussed in U.S. Pat. No. 7,001,861, U.S. Pat. No. 6,942,713, U.S. Pat. No. 6,620,751, and U.S. Pat. No. 7,259,120, which patents are incorporated by reference herein. Such AT-based bodies are used as an alternative to cordierite and silicon carbide (SiC) bodies for high-temperature applications, such as automotive emissions control applications. The systems and methods disclosed herein apply to any type of greenware amenable to RF or MW drying techniques.

In an embodiment, master controller MC is or includes a computer or like device that has, for example, a floppy disk drive, CD-ROM drive, DVD drive, magnetic optical disk (MOD) device (not shown), or any other digital device including a network-connecting device such as an Ethernet device (not shown) for reading instructions and/or data from a computer-readable medium, such as a floppy disk, a CD-ROM, a DVD, a MOD or another digital source such as a network or the Internet, as well as yet to be developed digital means. In another embodiment, master controller MC executes instructions stored in firmware (not shown).

In an example, master controller MC is programmed to perform the functions and carry out the methods described herein. The term computer as used herein broadly refers to computers, processors, microcontrollers, microcomputers, programmable logic controllers, application specific integrated circuits, field-programmable gate arrays, and the like.

In an example, software may be employed to implement or aid in performing the disclosed methods directed to maintaining extrudate shape to within a select specification. The software may be executable by the general-purpose computer. In operation, the software and possibly the associated data records may be stored within a general-purpose computer platform. At other times, however, the software may be stored at other locations and/or transported for loading into the appropriate general-purpose computer systems. Hence, the embodiments discussed herein may involve one or more software products in the form of one or more modules of code carried by at least one machine-readable medium. Execution of such code by a processor may be used to implement embodiments discussed and illustrated herein. Also, embodiments of master controller MC include the use of multiple computers, including, a master controller, one or more slave controllers, one or more supervisory controllers, and combinations thereof. In an example, master controller MC includes a display 300.

### Batch Materials

In an example, the aqueous-based ceramic precursor mixture formed in wet tower 20 comprises a batch material mixture of ceramic (such as cordierite) forming inorganic precursor materials, an optional pore former such as graphite or starch, a binder, a lubricant, and a vehicle. The inorganic batch material components can be any combination of inorganic components (including one or more ceramics) which can, upon firing, provide a porous ceramic having primary sintered phase composition (such as a primary sintered phase composition of cordierite or aluminum titanate).

In an example embodiment, the inorganic batch material components can be selected from a magnesium oxide source, an alumina-forming source, and a silica source. The batch material components are further selected so as to yield a ceramic article comprising predominantly cordierite, or a mixture of cordierite, mullite and/or spinel upon firing. For example, the inorganic batch material components can be selected to provide a ceramic article that comprises at least about 90% by weight cordierite, or more preferably 93% by weight cordierite. In an example embodiment, the cordierite-containing honeycomb article consists essentially of, as characterized in an oxide weight percent basis, from about 49 to about 53 percent by weight SiO₂, from about 33 to about 38 percent by weight Al₂O₃, and from about 12 to about 16 percent by weight MgO. To this end, an exemplary inorganic cordierite precursor powder batch material composition preferably comprises about 33 to about 41 weight percent of an aluminum oxide source, about 46 to about 53 weight percent of a silica source, and about 11 to about 17 weight percent of a magnesium oxide source. Exemplary non-limiting inorganic batch material component mixtures suitable for forming cordierite are disclosed in U.S. Pat. Nos. 3,885,977; 5,258,150; US Pubs. No. 2004/0261384 and 2004/0029707; and RE 38,888, which are all incorporated by reference herein.

The inorganic ceramic batch material components can include synthetically produced materials such as oxides, hydroxides, and the like. Alternatively, they can be naturally occurring minerals such as clays, talcs, or any combination thereof, which are selected depending on the properties desired in the final ceramic body.

In one example, an “inorganic batch material” includes ceramic-based mixtures that are “substantially inorganic” because they typically include some pore-forming organics that make up a minor portion (e.g., about 1% to about 7%) of the mixture.

In one embodiment, a relationship between the indirect temperature measured for a given ceramic precursor formulation and a temperature directly measured is determined and then used to infer the temperature of the batch material 34 including, for example, the batch core temperature T_{34C} by indirectly measuring the temperature of batch material and using the known relationship for the two temperatures to estimate the batch material's core temperature.

In another embodiment, heat transfer from the extruder barrel 91 to the batch material 34 (or from the batch material to the barrel) is regulated at a rate sufficient to maintain a desirable difference between the batch material's core temperature T_{34C} and its skin temperature T_{34S}. The term “heat transfer,” as used herein, includes cooling the batch material's temperature by transferring heat from the batch material to at least one extruder barrel 91. In one embodiment, the temperature range is selected such that it produces an extrudate 100 with a uniform shape, resulting in a larger number of error-free ceramic honeycomb structures and a reduced need for reworking.

### Temperature Sweep Curves

For most, if not all, ceramic precursor batch materials 34 that can be extruded to form an extrudate 100, there are optimal core and skin temperatures T_{34C} and T_{34S}. These optimal core and skin temperatures can change due to variations in batch rheology. Extrudates 100 formed at or near the optimal core and skin temperatures for a given batch formulation will generally have fewer imperfections than those formed at sub-optimal temperatures.

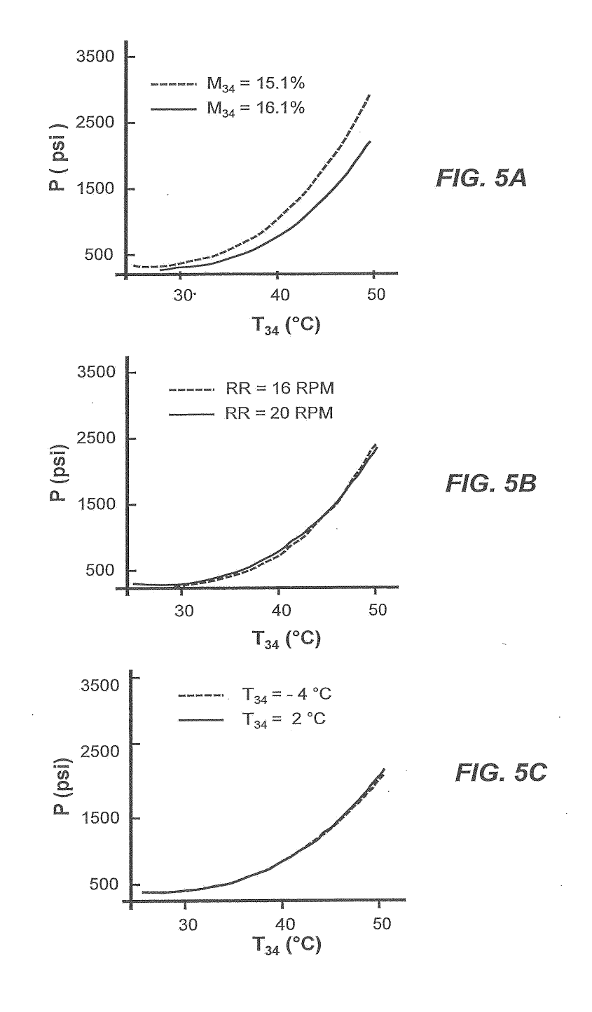

FIG. 5A through FIG. 5C are plots of experimentally measured values of the pressure P (psi) versus the batch temperature T₃₄ (° C.) for two different batch water values of M₃₄=15.1% (dashed line) and 16.1% (solid line) (FIG. 5A), for two different extrusion screw rotation rates of RR=16 RPM (dashed line) and 20 RPM (solid line) (FIG. 5B) and for two different barrel temperatures T₉₁=−4° C. (dashed line) and +2° C. (solid line) (FIG. 5C). The curves in the plots are called temperature sweep curves or just sweep curves. The pressure P is measured while conducting the temperature sweep test using, for example, a capillary rheometer. The capillary rheometer used to collect the data for the plots in FIG. 5A through FIG. 5C included a small ram extruder with a 1 mm (diameter opening) die. The ram is pushed at a constant rate while the barrel is heated at a constant rate, and pressure sensors in the barrel record the pressure P.

FIG. 5A through FIG. 5C reveal that the batch water content M₃₄ has a substantial impact on the sweep curve. As water is added to batch material 34, the sweep curve moves down, thereby reducing the pressure P, and also moves to the right, thereby increasing the gelation temperature of the batch material.

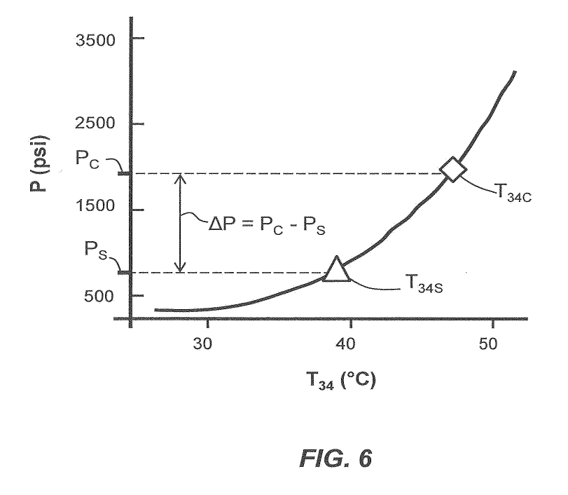

The locations of the skin and core temperatures T_{34S} and T_{34C} on the sweep curve have a significant impact on the shape of extrudate 100. FIG. 6 is a hypothetical temperature sweep curve representative of those shown in FIG. 5A through FIG. 5C and that includes example skin and core batch temperatures T_{34S} and T_{34C} indicated by a triangle and a diamond, respectively. As the batch temperature T₃₄ increases and moves up the sweep curve, the pressure P increases and the batch flow rate decreases as batch material 34 is extruded through die 92. Conversely, as the batch temperature T₃₄ decreases and moves down the sweep curve, the batch flow rate of batch material 34 increases through die 92.

As the core temperature T_{34C} is usually greater than the skin temperature T_{34S}, the extrudate 100 exhibits a flow differential corresponding to this temperature differential. Thus, the temperature differential between the batch material core and skin relates directly to the pressure differential, with the batch material core temperature T_{34C} being associated with core pressure P_{C} and batch material skin temperature T_{34S} being associated with skin pressure P_{S} via the sweep curve. And the pressure differential ΔP is associated with the shape of extrudate 100.

Differences in the pressure differential ΔP from its optimal value based on the skin and core pressures, which depend not only on the skin and core temperatures, respectively, but also on the batch water M₃₄ and rotation rate RR, are the root cause of rheology induced shape errors in extruded ceramic honeycomb structures 100.

Table 1 below summarizes a number of example extrusion parameter values for a number of corresponding sweep curves, which are shown in the indicated Figures.

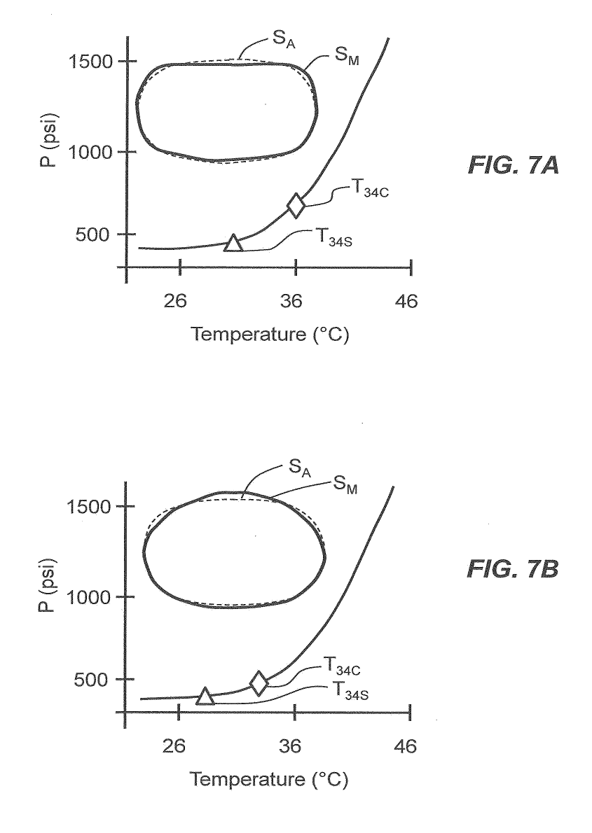

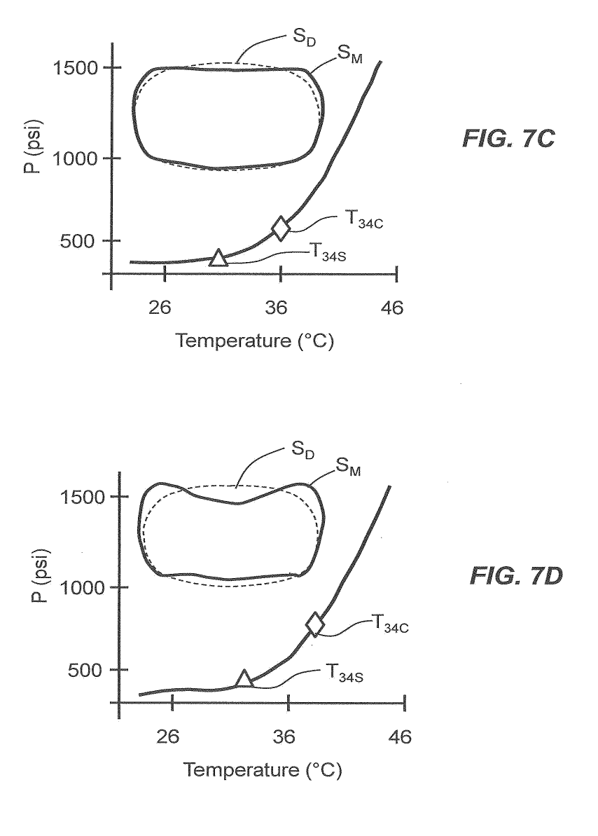

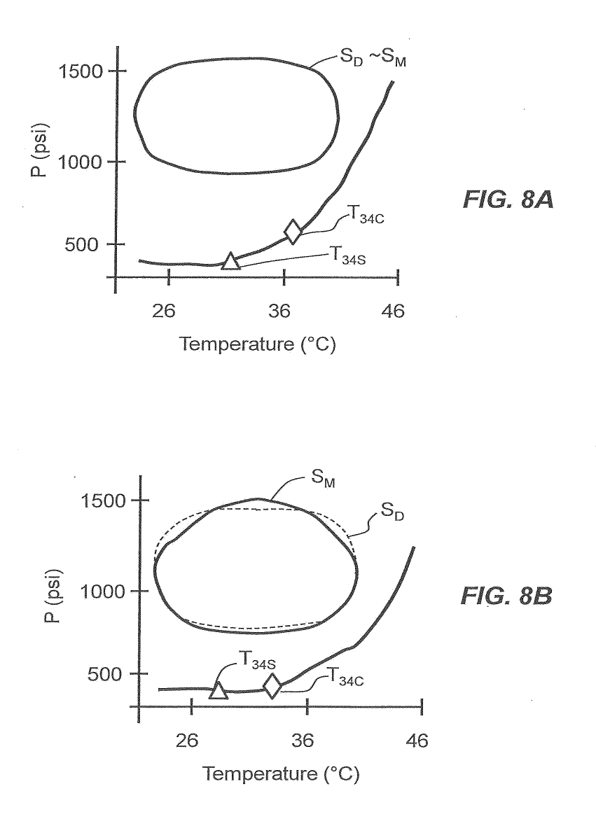

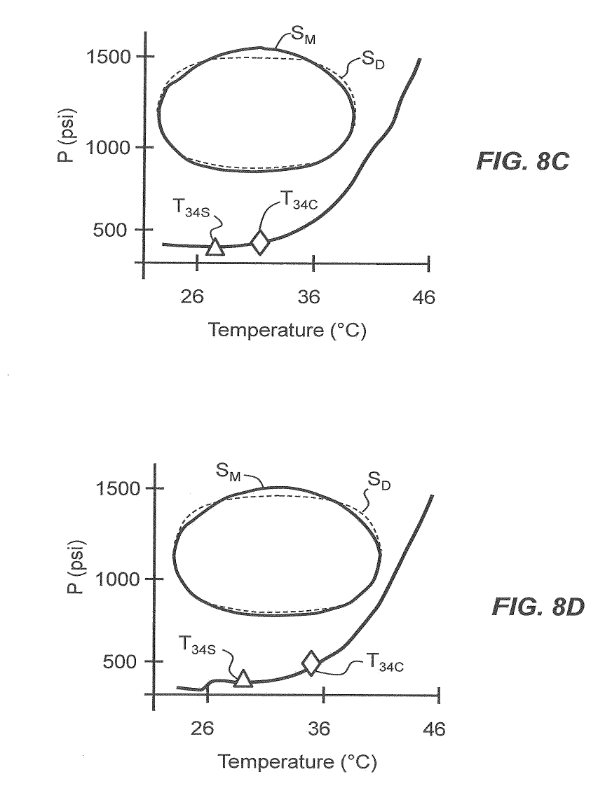

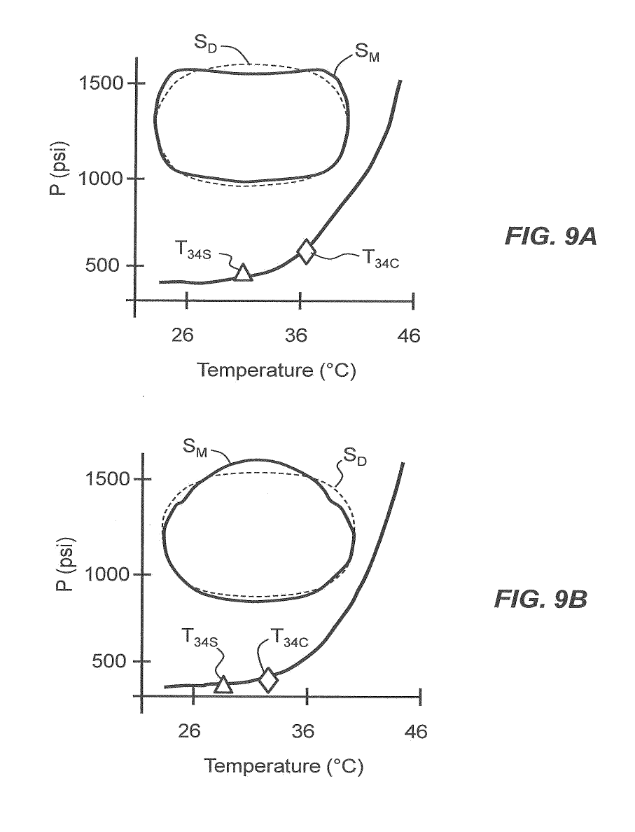

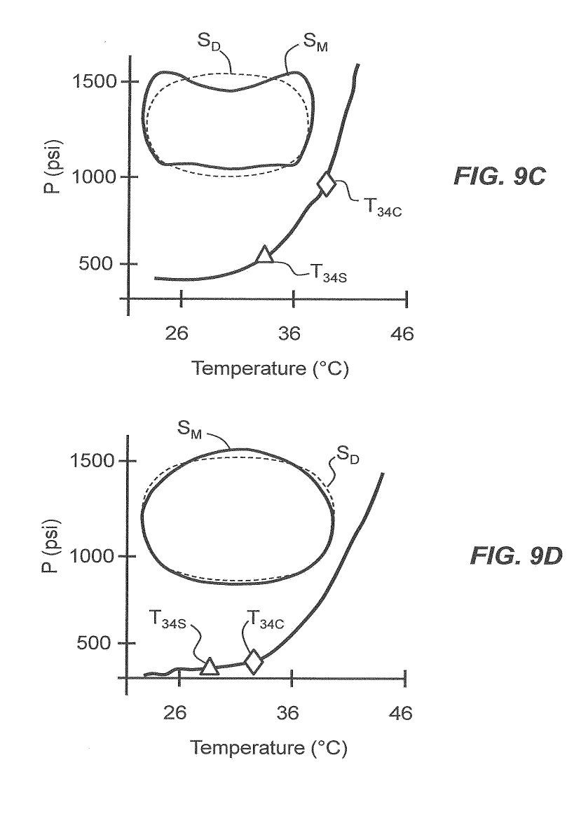

TABLE 1
Example Extrusion Parameters

| FIGURE | RR (RPM) | T91 (° C.) | M34 (%) |
|---|---|---|---|
| FIG. 7A | 19.2 | −2.8 | 15.5 |
| FIG. 7B | 16.8 | −2.8 | 15.5 |
| FIG. 7C | 16.8 | 0.8 | 15.5 |
| FIG. 7C | 18 | 0.8 | 15.5 |
| FIG. 8A | 19.2 | 0.8 | 16.1 |
| FIG. 8B | 16.8 | 0.8 | 16.1 |
| FIG. 8C | 16.8 | −2.8 | 16.1 |
| FIG. 9A | 19.2 | 1 | 16.1 |
| FIG. 9B | 18.0 | 1 | 15.8 |
| FIG. 9C | 20.0 | 1 | 15.8 |
| FIG. 9D | 16.0 | 1 | 15.8 |

FIG. 7A through FIG. 7D are sweep curves where the rotation rate RR and the barrel temperature T₉₁ were varied and the batch water M₃₄ was kept at a constant 15.5%. The skin and core batch material temperatures T_{34S} and T_{34C} on each sweep curve are represented by a triangle and a diamond, respectively. Also shown along with each sweep curve is a cross-sectional plot of the desired extrudate shape S_{D} (dashed line), along with the actual measured extrudate shape S_{M} (solid line) as measured by a laser-based shape sensor unit 210.

FIG. 8A through FIG. 8D are sweep curves similar to FIG. 7A through FIG. 7B, but where the batch water M₃₄ was kept at a constant 16.1%. FIG. 9A through FIG. 9D are sweep curves similar to FIG. 7A through FIG. 7B, but where the batch water M₃₄ and rotation rate RR was varied while the barrel temperature T₉₁ was kept at a constant 1° C.

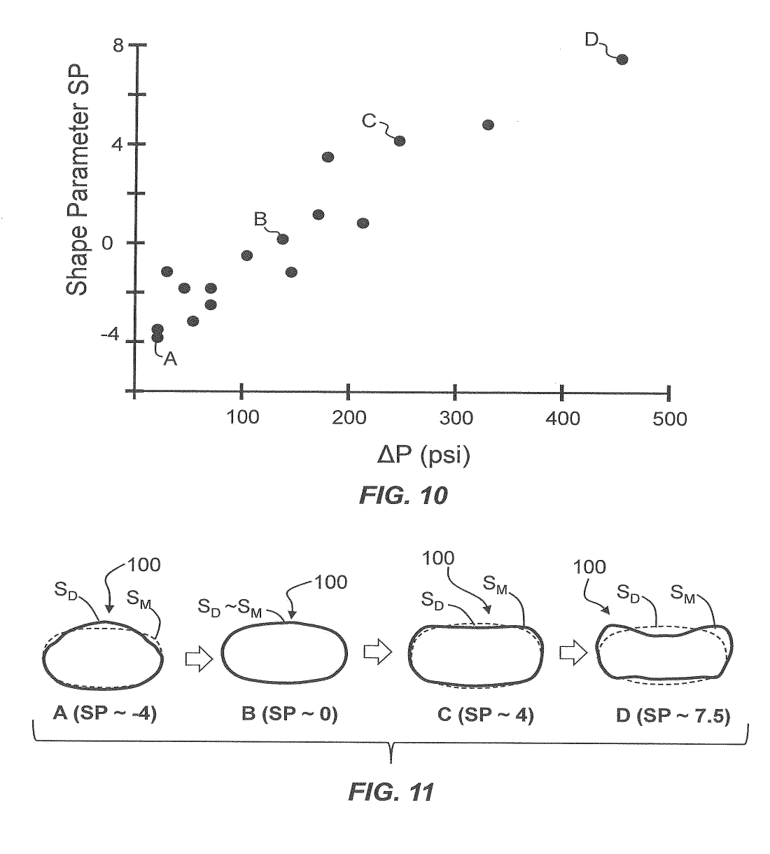

FIG. 10 plots the pressure differential ΔP (psi) versus shape parameter SP based on the plots of FIGS. 7A-7D, 8A-8D and 9A-9D. The various values for the pressure differential correspond to certain extrudate shapes that can be characterized and assigned a shape parameter. The example shape parameters SP associated with FIG. 10 range from −4 to +8, with the best shape have a shape parameter SP=0, which in FIG. 10 is associated with a pressure differential ΔP of about 150 psi. The shape parameters SP can be based on extrudate shapes that are known to occur during the particular extrusion process.

In an example, the pressure differential ΔP can be adjusted through hardware compensation, i.e., by changing the configuration of system 10, such as the die size and shape. This could be done to move to the flatter portion of the sweep curve, which results in a more stable extrusion process because this portion of the sweep curve more readily accommodates variations in batch rheology.

FIG. 11 illustrates the evolution of extrudate shape SP with pressure differential ΔP for four data points A, B, C and D from FIG. 10. Data point B has a shape parameter SP=0 and has the best shape, i.e., the least amount of shape error between the desired shape S_{D} and the measured shape S_{M}. Data point A corresponds to a shape parameter SP of about −4 and suffers from “pull in,” where the sides (along the major axis of the oval) are pulled in so that the shape contour is more circular than the desired oval shape. Data point C corresponds to a shape parameter SP of about 4 and is more elongate and squared off as compared to the ideal oval shape. Data point D corresponds to a shape parameter SP of about 7.5 and is even more elongate and more squared off than shape C, and thus deviates even farther from the ideal shape than the shape associated with shape parameter SP=4. In an example, measured and desired shapes S_{M} and S_{D}, along with shape parameter SP, can be displayed on display 300.

An aspect of the disclosure is real-time, closed-loop shape control of extrudate 100 based on the batch water M₃₄, the barrel temperature T₉₁ and the rotation rate RR of the one or more extrusion screws 93. A summary of the relationships between these three process control parameters and the differential ΔP as measured by a capillary rheometer is presented in Table 2, below. The extrusion data of Table 2 were taken from an extrusion process that used standard AT batch material extruded through a standard oval-shaped die.

TABLE 2
Effect of unit parameter change on ΔP

| Parameter | δ (ΔP) | p-Value |
|---|---|---|
| M₃₄ | −321.9 | 0.000 |
| RR | 52.2 | 0.002 |
| T₉₁ | 29.2 | 0.004 |

The δ(ΔP) column quantifies the change in the pressure differential ΔP as a function of a change of 1 unit in the given process parameter. For batch water M₃₄, the unit change is 1%. For barrel temperature, the unit change is 1° C. For rotation rate RR, the unit change is 1 RPM.

The date of Table 2 indicate that a 1% change in batch water M₃₄ changes the pressure differential ΔP by about −322 psi. A change in the rotation rate RR of 1 RPM changes the pressure differential ΔP by about +50 psi. A change in barrel temperature T₉₁ of 1° C. changes the pressure differential ΔP by about +29.2.

The p-value in Table 2 indicates the statistical significance of the relationship of the different parameters to the pressure differential ΔP. A p-value of 0.01 or less indicates that there is a very strong relationship with a 99% or greater confidence level. From Table 2, it can be seen that all three process parameters M₃₄, T₉₁ and RR are all highly correlated to the pressure differential ΔP, and thus to the shape S of extrudate 100.

Thus, an aspect of the disclosure is a real-time, closed-loop method for controlling a shape of extrudate 100 by exploiting the close relationship of the batch water M₃₄, the barrel temperature T₉₁ and the rotation rate RR of the one or more extrusion screws 93 to the extrudate shape S. The method includes forming extrudate 100 by extruding batch material 34 through an extruder barrel 91 and through an extruder die 92. The method also includes measuring the batch water M₃₄ using, for example, moisture sensor 230, and providing an electrical batch water signal S₃₄ to master controller MC, or by determining the amount of water added to the batch material in water unit 50. The method also includes measuring the barrel temperature T₉₁ using, for example, barrel temperature sensor 220, and providing an electrical barrel temperature signal S_{T91} to master controller MC. The barrel temperature T₉₁ can also come from a barrel temperature control system 210. In an embodiment, barrel temperature sensor 220 is part of barrel temperature control system 210.

Optional steps include measuring the extrudate temperature profile either manually on a sample extrudate 100 or automatically with in-line temperature sensor 250 and correlating this data with the extrudate shape measurements to ensure correspondence between the extrudate shape measurements and the batch rheology.

The method further includes measuring the extrusion screw rotation rate RR using, for example, motor 95, and providing an electrical rotation rate signal S_{RR} to master controller MC. The method also includes measuring the shape of extrudate 100 as it exits the die using, for example, shape sensor unit 240, and providing an electrical shape signal S₁₀₀ to master controller MC. The method also includes adjusting at least one of the batch water M₃₄, barrel temperature T₉₁ and rotation rate RR while extruding the extrudate 100 to maintain the extrudate shape to within a select tolerance. In an example, the select tolerance is defined as the measured contour not deviating from an ideal or desired contour by no more than ±1.0 mm. In an example, master controller MC is configured to compare the desired contour to the measured contour and to inform the end-user of extrusion system 10 (e.g., via a visual graphic on display 300 or via an audio alarm or both) if the measured shape is outside of the select tolerance.

The adjustment of the batch water M₃₄ may be accomplished via the operation of master controller MC. In an example, master controller MC sends a batch water control signal S₂₀ to water tower 20, which controls the moisture content of batch material 34, e.g., by causing water unit 50 to increase or decrease the amount of water added to the batch material. Likewise, the adjustment of the barrel temperature T₉₁ may be accomplished by main controller MC sending a control signal S₂₁₀ to barrel temperature control system 210 which, for example, in response thereto can control the flow of cooling fluid to set the barrel temperature T₉₁ to a desired value. Likewise, master controller MC can send a motor control signal S₉₅ to motor 95 to cause a change in the rotation rate RR of one or more extrusion screws 95. When the shape of extrudate 100 is within the select tolerance, the three parameter values are maintained and the shape of extrudate is monitored for shape changes (errors) that would require changing one or more of the batch water M₃₄, the barrel temperature T₉₁ and the rotation rate RR in response. In an example, master controller MC includes (e.g., via software) a quantified relationship between the batch material moisture measurement, the barrel temperature measurement, the extrusion screws rotation rate and the extrudate shape.

In an example, for a given type of batch material 34, extrudate 100 is formed continuously as the batch water M₃₄, the barrel temperature T₉₁ and the rotation rate RR are varied while the extrudate shape is measured to establish sweep curves and shape parameter values that can be stored in master controller MC. Master controller MC can also process the stored parameter values to establish the aforementioned quantified relationship between the parameters. As described above, as an option the temperature profile of extrudate 100 can be measured either manually on a sample extrudate 100 or using in-line temperature sensor 250. This temperature profile data is then used to assist in forming the quantified relationship and assuring that the batch rheology is consistent with the shape measurements.

Once the batch water M₃₄, the barrel temperature T₉₁ and the rotation rate RR are measured, one or more of these parameters can then be adjusted to correct shape errors and maintain extrudate 100 within a select shape tolerance.

It will be apparent to those skilled in the art that various modifications and variations can be made to the present disclosure without departing from the spirit and scope of the disclosure. Thus, it is intended that the present disclosure cover the modifications and variations of these disclosures provided that they come within the scope of the appended claims and their equivalents.

What is claimed is:

1. A method for controlling a shape of a ceramic precursor extrudate, comprising:
forming the extrudate by extruding a ceramic precursor batch material through a barrel and through an extruder die, the barrel having one or more extrusion screws within the barrel that control a rate of extrusion of the batch material through the die in forming the extrudate;
determining a batch material water content;
measuring at least one of a barrel temperature and a screw temperature;
measuring a rotation rate of one or more of the extrusion screws within the barrel;
measuring the extrudate shape as the extrudate exits the die; and
adjusting at least one of the batch material water content, barrel temperature, screw temperature, and rotation rate in real time to maintain the extrudate shape to within a select tolerance.

2. The method according to claim 1, further comprising determining the batch material water content by measuring an amount of water added to the batch material using a delivery scale.

3. The method according to claim 2, further comprising adjusting the batch material water content by changing the amount of water added to the batch material.

4. The method according to claim 1, further comprising the select tolerance being equal to +1/−1 mm.

5. The method according to claim 1, further comprising forming the batch material to include aluminum titanate or cordierite.

6. The method according to claim 1, further comprising measuring the extrudate shape using a shape sensor unit arranged adjacent the die.

7. The method according to claim 1, further comprising determining extrudate shape parameters based on the measured batch material water content, the measured barrel temperature, the measured screw temperature, the rotation rate and measured extrudate shapes.

8. The method according to claim 7, further comprising identifying an optimum extrudate shape from the shape parameters.

9. The method according to claim 1, further comprising:
measuring an extrudate temperature profile either manually or automatically; and
correlating the measured extrudate temperature profile to the measured extrudate shape.

10. The method according to claim 1, further comprising:
defining a set of pressure versus temperature sweep curves;
determining extrudate shapes associated with each temperature sweep curve; and
performing said adjusting of at least one of the batch material water content, barrel temperature, screw temperature and rotation rate based on the determined extrudate shapes.

11. A ceramic precursor extrudate control system for controlling a shape of a ceramic precursor extrudate, comprising:
an extruder comprised of a barrel adapted to contain a batch material;
an extruder die operably disposed relative to the extruder barrel;
an extrusion screw system that includes at least one extrusion screw within the barrel and having a variable rotation rate, the extrusion screw system controlling a rate of extrusion of the batch material through the die and providing an extrusion screw rotation rate measurement;
a temperature control system configured to control at least one of a barrel temperature and a screw temperature, and to provide a measurement of at least one of the barrel temperature and the screw temperature;
a water unit configured to add a select amount of water to the batch material, with the select amount of water corresponding to a batch material moisture content;
a shape sensor arranged adjacent the die and configured to provide an extrudate shape measurement; and
a controller configured to receive the batch material moisture content, the barrel temperature measurement, the rotation rate and the measured extrudate shape, and cause a change in at least one of the batch material moisture content, the barrel temperature, the screw temperature, and the rotation rate in real time to maintain the extrudate shape to within a select tolerance.

12. The system according to claim 11, further comprising the controller having a quantified relationship between the batch material moisture measurement, the barrel temperature measurement, the screw temperature measurement, the rotation rate and the extrudate shape.

13. The system according to claim 10, wherein the controller is operably connected to a water unit operable to add water to the batch material, with the controller being configured to control an amount of water the water unit adds to the batch material to change the batch material moisture content.

14. The system according to claim 10, wherein the water unit includes a delivery scale operable to add a select amount of water to the batch material.

15. A method for controlling a shape of a ceramic extrudate formed by an extrusion system, comprising:
extruding batch material through an extruder barrel and through an extruder die using at least one extrusion screw to form the extrudate;
measuring a shape of the extrudate immediately adjacent the die;
determining a batch material water content;
measuring a temperature of at least one of the extruder barrel and the extrusion screw;
measuring a rotation rate of the least one extrusion screw;
adjusting at least one of the batch material water content, barrel temperature, screw temperature and the rotation rate in real time to maintain the extrudate shape to within a select tolerance.

16. The method according to claim 15, further comprising determining the batch material water content by measuring an amount of water added to batch material.

17. The method according to claim 16, further comprising adjusting the batch material water content by changing the amount of water added to the batch material.

18. The method of claim 15, further comprising performing said adjusting via operation of a controller operably configured to control the operation of the extrusion system.

19. The method of claim 15, further comprising defining the select tolerance as a measured shape contour not deviating from a desired shape contour by more than ±1.0 mm.

20. The method of claim 15, further comprising determining extrudate shape parameters based on the measured batch material water content, the measured barrel temperature, the measured screw temperature, the rotation rate and measured extrudate shapes, and identifying an optimum extrudate shape from the shape parameters.
